(19) United States
(12) Patent Application Publication
(10) Pub. No.: US 2005/0186043 A1
(43) Pub. Date: Aug. 25, 2005

(54) Method and assembly for mounting a drill bit into a shank

(76) Inventor: David Fuller, Coventry, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/051,929

(22) Filed: Feb. 4, 2005

Related U.S. Application Data
(60) Provisional application No. 60/542,172, filed on Feb. 5, 2004.

(51) Int. Cl. B23B 51/00

(52) U.S. Cl. 408/239 R; 408/226

(57) ABSTRACT

An assembly and a mounting means for installing a drill bit into a shank thereby allowing the drill bit to be integrated into a modular adapter system is provided. The present invention further provides a mounting means for installing a drill bit into a shank that wherein the drill bit is aligned with the axis of rotation of the shank while also including features that provide for positive retention of the drill bit, superior resistance to twist out and the ability to replace the drill bit as it becomes worn or breaks.

### CROSS-REFERENCE TO RELATED APPLICATIONS

This application is related to and claims priority from earlier filed U.S. Provisional Patent Application No. 60/542,172, filed Feb. 5, 2004, the contents of which are incorporated herein by reference.

### BACKGROUND OF THE INVENTION

The present invention relates generally to a new mounting configuration for inserting and retaining a drill bit in an adapter chuck. More specifically, the present invention relates to unique tapered drill and receiver chuck configuration that operates in conjunction with a set screw and keyway to firmly retain the drill bit during operation while also allowing the drill bit to be removed and replaced in the event that the bit breaks or wears out.

Currently in the drill industry there is a trend to provide drill bits that can be integrated into a modular quick-change system. In particular, the industry provides an adapter device that is configured for installation into a into a drill chuck. One end of the adapter is inserted into the drill chuck and retained by the jaws of the chuck once the chuck is tightened. The opposite end of the adapter is configured to include a female receiver port into which the desired driver bit is inserted. The typical standard for this type adapter device is to provide a ¼″ hexagonal male end for insertion into the drill chuck and a ¼″ hexagonal female receiver port on the opposite end of the adapter into which the desired driver bit is placed. It can be appreciated however, that this is just one possible arrangement and is provided for illustration of the current standard and is not meant to be limiting on the present disclosure. Once the driver bit is placed into the receiver port, the adapter device retains driver bits in the receiver port using either a magnet or a ball bearing retention means. In this manner, a user can easily change between various types of bits as needed simply by removing and replacing the driver bit, provided all of the driver bits include a ¼″ hexagonal male tail shaft. For example, the user can easily swap a #2 Phillips tip for a #3 Philips tip or a square drive tip simply and easily without having to open and re-tension the drill chuck.

Further, to make this type of system more convenient for the user, many manufactures have attempted to create drill bits that are mated with shanks, which include ¼″ hexagonal male shafts that are accepted by the receiver port. In this manner, a user can easily drill a pilot hole using drill bit mated with a shank and then switch to a screw driver bit to install a screw without having to loosen the drill chuck to remove the drill bit and reinstall a driver bit.

In the prior art, there are typically two ways in which a drill bit is mated with an adapter shank. In both cases, the manner in which the drill is mounted into the shank is fairly unreliable. One style used in the prior art provides an oversized opening in the shank to receive a round drill bit. A set screw in the side of the adapter shank is tightened against the drill bit in order to retain it in the shank. In this arrangement, the drill bit, when subjected to torque, frequently ended up getting caught in the material being drilled, while the adapter shank spun around the drill bit. To solve this problem, specialized drill bits that include a flat keyway on the rear shaft thereof were provided. The flat surface provides a positive surface against which the set screw is engaged making the joint resistant to rotational slippage. The problem with this particular configuration is that due to the oversized nature of the bore in the shank, the bit is generally retained in a position that is off center from the rotational center of the shank resulting in a large amount of run-out at the tip of the drill bit.

An alternative style that attempts to correct the difficulty noted above regarding the run-out and off centered mounting of the drill bit utilizes a tapered opening in the shank and a corresponding tapered shaft on the end of the drill bit. The drill bit is installed into the shank by spinning the two parts together until they jam. This technique is referred to as spin welding. While this system provides for centering the drill bit in the chuck, the drill bit is permanently installed and cannot be easily separated from the chuck if the drill bit breaks or wears out. An additional difficulty that results from this assembly arises from the increasing trend to use tapered cutting edge drill bits for drilling pilot holes. Since the tapered drill bits cut along the entire length of the shoulder, a great deal more torque is transferred from the drill bit into the shank as compared to traditional straight drill bits. Occasionally, the additional torque generated by tapered drill bits as they are used to drill particularly hard woods is of sufficient force to cause the drill bit to spin out of the shank. Once the drill bit is dislodged in this manner, it cannot be reinstalled into the shank and the entire assembly must be replaced. Also, if the cutting edge of the drill bit becomes dull or if the drill bit breaks, the drill bit cannot be replaced, again resulting in the need for replacing the entire assembly.

There is therefore a need for a unique drill bit and shank assembly that facilitates interchangeable use in a standard drill interface system. There is a further need for an improved assembly wherein a drill bit is mounted into a shank in a self centered position while also being capable of resisting the additional torque generated by drill bits having tapered shoulders. Finally, there is a need of an assembly that includes all of the features noted above while also allowing removal and replacement of the drill bit within the shank.

### BRIEF SUMMARY OF THE INVENTION

In this regard, the present invention provides for an assembly and a mounting means for installing a drill bit into a shank thereby allowing the drill bit to be integrated into a modular adapter system. The present invention further provides a mounting means for installing a drill bit into a shank that overcomes the axial alignment issue described above while also providing positive retention of the drill bit, superior resistance to twist out and the ability to replace the drill bit as necessary.

The present invention generally includes two parts, a drill bit and a shank. In the present invention, both the receiver opening in the shank and the end of the drill bit are tapered as would typically be provided in the spin weld prior art method described above. In particular, the shank includes an opening that is aligned with the central axis of the shank. The walls of the opening in the shank are preferably tapered at approximately 0.006″ per inch. Additionally, the tail of the drill bit itself also includes a corresponding taper. In this manner, the drill bit, when received in the receiver opening in the shank is forced into alignment with the central axis of the shank by the concentric taper of both the receiver opening and the tail of the drill bit. As the drill bit is further pressed into the tapered receiver opening, the frictional forces between the tail of the drill bit and the walls of the receiver opening also interact to retain the drill bit while not in a permanent fashion such as is the case in the spin weld type assemblies. To maintain the drill bit in the installed position and prevent the drill bit from spinning out of the shank, a set screw is provided in the wall of the shank that engages a corresponding keyway in the tail of the drill bit.

In addition to providing a more reliable and accurate assembly as compared to the prior art devices, the present invention includes the additional benefit of allowing replacement of the drill bit should the drill bit break or become dull. The user simply loosens the set screw and taps the shank off of the drill bit, thereby allowing a new drill bit to be installed into the shank.

It is therefore an object of the present invention to provide drill bit and shank assembly that facilitates interchangeable use in a standard drill interface system. It is a further object of the present invention to provide an improved assembly wherein a drill bit is mounted into a shank in a self centered position while also being capable of resisting and transferring the additional torque generated by drill bits having tapered shoulders. It is yet a further object of the present invention to provide a drill bit and shank assembly that can be interfaced with an interchangeable system while including a self centering mounting feature and also allowing removal and replacement of the drill bit within the shank.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a perspective view of the drill bit and shank assembly of the present invention;

FIG. 2 is an exploded perspective view of the drill bit and shank assembly of the present invention; and

FIG. 3 is a cross sectional view of the drill bit and shank assembly of the present invention taken along line 3-3 of FIG. 1.

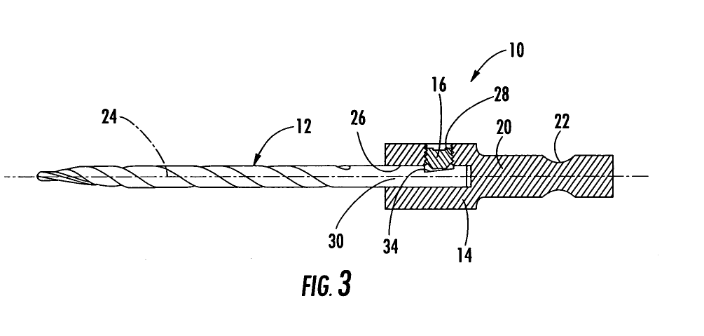

### DETAILED DESCRIPTION OF THE INVENTION

Now referring to the drawings, the drill bit and shank assembly of the present invention is shown and generally illustrated at 10 in the figures. As can be seen assembly 10 principally includes three components, a drill bit 12, a shank 14 and a set screw 16. The drill bit 12 is received in a receiver opening 18 in the shank 14 and retained therein by both frictional forces and use of the set screw 16 to produce a completed assembly wherein a drill bit 12 is mounted into a shank 14 that is compatible with a standard interchangeable bit system as is known in the art.

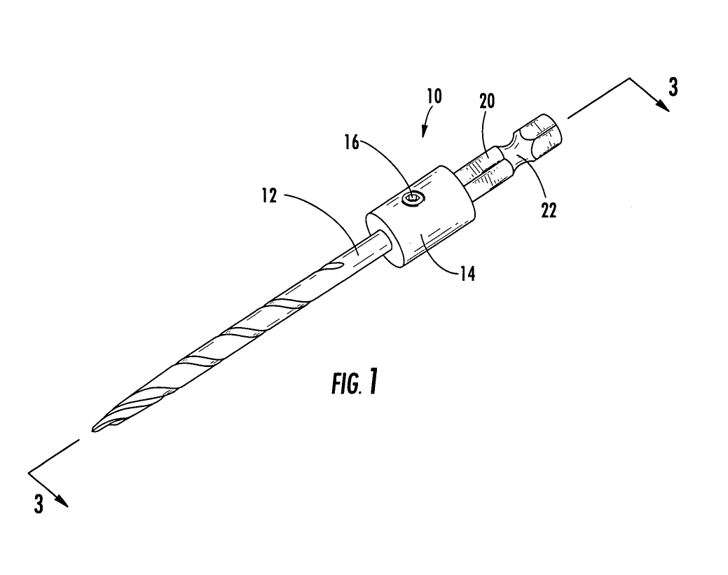

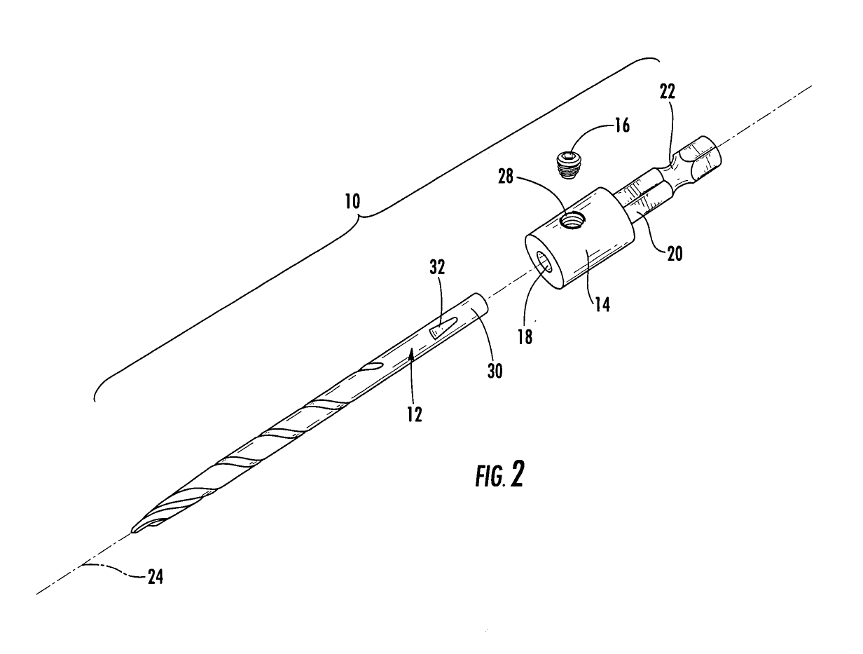

Turning to FIGS. 1 and 2, the principal component of the assembly 10 is the shank 14. The shank 14 is the interface between the drill bit 12 and a modular adapter system (not shown) with which the assembly 10 is to be used. The shank 14 is formed to have one end that includes a tail shaft 20 for interfacing the shank 14 with a drill adapter as was disclosed above. The tail shaft 20 in the preferred embodiment is formed to have a ¼″ hexagonal cross-sectional profile. This particular profile was chosen so that the tail shaft 20 of the shank 14 is compatible with the current standard in the industry. In particular, as was stated above, it is common in the industry to provide an adapter having a ¼″ hexagonal receiver that is mounted into a drill. Therefore, the shank 14 of the present invention is configured to be compatible with this type system. This disclosure, however, is not meant to be limiting with regard to configuration or size and one skilled in the art could easily modify the size and shape of the tail shaft 20 as necessary to make the shank 14 of the present invention compatible with any variety of known interface standards or any standard that is developed in the future.

The shank 14 is preferably formed from a metallic material. Further, in some cases, the shank 14 may preferably be formed from a ferro-magnetic material thereby allowing the shank 14 to be retained in the receiver on the drill adapter by a magnet located therein. Additionally, the tail shaft 20 of the shank 14 can also be seen to include a detent 22 at one end thereof. The detent 22 is provided to allow the shank 14 to be retained in the receiver of a drill adapter that utilizes a ball bearing retention method as was described above.

The end of the shank 14 opposite the tail shaft 20 is formed to include a receiver opening 18. The receiver opening 18 is a circular hole with its center being aligned with the central axis 24 of the shank 14. In particular, the receiver opening 18 is formed so that it is concentric with the central axis of rotation 24 of the shank 14. The walls 26 of the receiver opening 18 are machined to include a slight inward taper as the walls 26 extend inwardly from the end of the shank 14. In the preferred embodiment, the taper is approximately 0.006″ per inch although any suitable taper specification may be used and still fall within the scope of the present disclosure. A threaded opening 28 is provided in the wall of the shank 14 that extends inwardly from the outer wall of the shank 14 into the interior of the receiver opening 18. The threaded opening 28 is configured to receive a set screw 16 as will be further described in detail below.

The drill bit 12 of the present invention may be either a traditional straight cutting drill bit or, in the preferred embodiment, a tapered shoulder drill bit 12. In a tapered shoulder drill bit 12, the cutting edge of the drill bit 12 is tapered from the tip of the drill bit 12 to the base of the drill bit 12. The tapered configuration allows the drill bit 12 to cut along the entire shoulder of the drill bit 12. While this is an advantageous feature that allows the drill bit 12 to create pilot holes for later installation of screws, it also results in transferring a great deal more torque from the drill bit 12 back into the shank 14 when the drill bit 12 is in use. The tail 30 of the drill bit 12 includes a slight taper that corresponds to the taper of the walls 26 of the receiver opening 18 in the shank 14. When the drill bit 12 is placed into the receiver opening 18 of the shank 14, the taper in walls 26 of the receiver opening 18 and the taper on the tail shaft 30 of the drill bit 12 cooperate to align and center the drill bit 12 concentrically in the receiver opening 18. As can be appreciated, this feature insures that the drill bit 12 is concentric within the receiver opening 18 and therefore in alignment with the center of rotation 24 of the shank 14. Since all of the elements are in alignment along their rotational center, run-out at the tip of the drill bit 12 is virtually eliminated. The corresponding tapers in both the receiver opening 18 and on the tail 30 of the drill bit 12 also serve to increase the contact surface area between the shank 14 and the drill bit 12 thereby providing an increased ability for the assembly 10 to transfer torque and resist spinning of the shank 14 relative to the drill bit 12 should the drill bit 12 become jammed.

Another feature of the assembly of the present invention that further resists drill bit 12 spin-out is the tapered keyway 32 provided on the tail shaft 30 of the drill bit 12. The tapered keyway 32 is a cut keyway in the tail shaft 30 of the drill bit 12 that has a key surface 34 that is tapered inversely relative to the taper on the surface of the tail shaft 30 of the drill bit 12. When the drill bit 12 is placed into the receiver opening 18 of the shank 14, a set screw 16 is installed into the threaded opening 28 in the wall of the shank 14 and tightened until the set screw 16 engages the key surface 34 on the drill bit 12. As the set screw 16 is tightened, it exerts a force on the tapered key surface 34 urging the drill bit 12 rearwardly and further into the receiver opening 18 against the taper of their respective sidewalls. This rearward force serves to further wedge the drill bit 12 into the receiver opening 18 while also further increasing the frictional contact between the sidewall 26 of the receiver opening 18 and the tapered tail shaft 30 of the drill bit 12. Additionally, as the set screw 16 engages the key surface 34 it provides a physical restraint that prevents the shank 14 from rotating relative to the drill bit 12.

It is the interaction between the tapered walls 26 of the receiver opening 18, the tapered tail shaft 30 of the drill bit 12, the tapered key surface 34 and the set screw 16, therefore, that all interact to concentrically center the drill bit 12 relative to the rotational axis 24 of the shank 14, enhance the ability of the shank 14 to transfer torque to the drill bit 12 while resisting spin-out and provide an assembly 10 wherein the drill bit 12 can be replaced should the drill bit 12 break or become worn. To replace the drill bit 12, the set screw 16 is removed and the old drill bit 12 is tapped out of the shank 14. A new drill bit 12 is then placed into the receiver opening 18 and the set screw 16 is replaced and tightened. This is a feature that was not available in the prior art drill bit/shank combinations. The replaceable feature of the drill bit 12 also allows the shank 14 and drill bit 12 assembly 10 of the present invention to be provided in a kit wherein a single shank 14 is provided with a plurality of different drill bits 12. For example, the kit may include several different diameter tapered drill bits 12 for use in drilling pilot holes that are suitable for different sized screws. Similarly, the kit may include several tapered drill bits and several straight drill bits. This feature could not be provided in the prior art spin weld devices because each bit had to be permanently mounted into a dedicated shank 14.

It is important to note that, while certain sizes and taper specifications have been described herein, various different taper pitches could be used on the walls 26 of the receiver opening 18 in the shank 14, the tail shaft 30 of the drill bit 12 and the tapered key surface 34 and still fall within the spirit of the present invention. The novelty of the present invention is found in the provision of all of these features and the manner in which they interact with one another not the precise geometry that is utilized to achieve the result.

It can therefore be seen that the present invention provides a novel drill bit assembly 10 that includes a shank 14 with a replaceable drill bit 12 that can further be integrated with an interchangeable drill adapter system. Further, the present invention provides a high quality assembly 10 that insures concentric alignment of the drill bit 12 and the shank 14, positive retention of the drill bit 12 within the shank 14 and replaceability of the drill bit 12 that has, before now, not been provided in the prior art. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A modular drill bit assembly comprising:
a drill bit having a body portion and a tail shaft, said tail shaft having an outer surface that is inwardly tapered from said body portion towards a terminal end, said outer surface of said tail shaft including a key way therein, said key way including a key surface that is tapered inversely relative to said taper on said outer surface of said tail shaft;
a shank including a receiver opening therein, said receiver opening having a sidewall that is inwardly tapered corresponding to the taper on said outer surface of said tail shaft, said shank further including an interface shaft; and
a set screw received in a threaded opening in said shank,
wherein said tail shaft is removeably received in said receiver opening, said set screw engaging said key surface and exerting a force thereon, said force urging said tail shaft into said receiver opening such that said tapered outer surface on said tail shaft and said tapered side wall in said receiver opening are urged into mated contact.

2. The modular drill bit assembly of claim 1, said interface shaft further comprising:
a hexagonal shaft extending from said shank opposite said receiver opening.

3. The modular drill bit assembly of claim 2, said hexagonal shaft having a diameter of ¼″.

4. The modular bit assembly of claim 2, said hexagonal shaft including a detent formed in the outer surface thereof, said detent extending around the circumference of the hexagonal shaft.

5. The modular bit assembly of claim 1, wherein said shank is formed from a ferrous metal.

6. The modular drill bit assembly of claim 1, said shank including a central axis passing through said receiver opening and said interface shaft, said drill bit including an axis of rotation, wherein said tapered sidewall and said tapered outer surface cooperating to substantially align said axis of rotation with said central axis when said tail shaft is installed in said receiver opening.

7. The modular drill bit assembly of claim 1, said body portion extending between a first end adjacent said tail shaft and a second distal end, said body portion of said drill bit being cylindrical and including a cutting edge disposed on said distal end.

8. The modular drill bit assembly of claim 1, said body portion extending between a first end adjacent said tail shaft and a second distal end, said body portion of said drill being tapered from said first end and said distal end, said drill bit having a cutting edge extending from said distal end to said first end.

9. A modular drill assembly in combination:
a drill bit comprising:
a body portion having first end and a distal end opposite said first end,
a tail shaft extending from said first end of said body portion to a terminal end, said tail shaft having an outer surface that is inwardly tapered from said body portion towards said terminal end,
a key way in said outer surface of said tail shaft, said key way including a key surface that is tapered inversely relative to said taper on said outer surface of said tail shaft; and
a shank comprising:
a shank body,
a receiver opening in said shank body, said receiver opening having a sidewall that is inwardly tapered corresponding to the taper on said outer surface of said tail shaft,
an interface shaft extending outwardly from said shank body,
a set screw received in a threaded opening in said shank body,
wherein said tail shaft is removeably received in said receiver opening, said set screw engaging said key surface and exerting a force thereon, said force urging said tail shaft into said receiver opening such that said tapered outer surface on said tail shaft and said tapered side wall in said receiver opening are urged into mated contact.

10. In the combination of claim 9, said interface shaft further comprising:
a hexagonal shaft extending from said shank opposite said receiver opening.

11. In the combination of claim 10, said hexagonal shaft having a diameter of ¼″.

12. In the combination of claim 10, said hexagonal shaft including a detent formed in the outer surface thereof, said detent extending around the circumference of the hexagonal shaft.

13. In the combination of claim 9, wherein said shank is formed from a ferrous metal.

14. In the combination of claim 9, said shank including a central axis passing through said receiver opening and said interface shaft, said drill bit including an axis of rotation, wherein said tapered sidewall and said tapered outer surface cooperating to substantially align said axis of rotation with said central axis when said tail shaft is installed in said receiver opening.

15. In the combination of claim 9, said body portion extending between a first end adjacent said tail shaft and a second distal end, said body portion of said drill bit being cylindrical and including a cutting edge disposed on said distal end.

16. In the combination of claim 9, said body portion extending between a first end adjacent said tail shaft and a second distal end, said body portion of said drill being tapered from said first end and said distal end, said drill bit having a cutting edge extending from said distal end to said first end.
